(19) United States
(12) Patent Application Publication
(10) Pub. No.: US 2008/0028984 A1
(43) Pub. Date: Feb. 7, 2008

(54) Anti-Reflective Coating for a Substrate

(75) Inventors: William A. Meredith, Faribault, MN (US); Joel T. Anderson, Cottage Grove, MN (US); John R. German, Prairie Du Sac, WI (US); Daniel P. Woodruff, Lakeville, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: Tru Vue, Inc.

(21) Appl. No.: 11/579,288

(22) PCT Filed: Oct. 20, 2004
(86) PCT No.: PCT/US04/34527

§ 371 Date: Apr. 12, 2007

Related U.S. Application Data
(60) Provisional application No. 60/514,936, filed on Oct. 28, 2003.

(51) Int. Cl. B32B 17/00; G02B 1/11

(52) U.S. Cl. 106/287.17; 106/287.18; 106/287.19; 427/419.2

(57) ABSTRACT

An anti-reflective coating for a substrate which includes an outer metal oxide layer with a refractive index greater than the refractive index of the substrate. The invention also relates to a method for making the anti-reflection coating.

### BACKGROUND OF THE INVENTION

1. Field of the Invention

The present invention relates to an anti-reflective coating for a substrate and more particularly to an anti-reflective coating that can be readily and easily cleaned and exhibit anti-static properties. The invention also relates to a method of making and applying the anti-reflective coating to a substrate.

2. Description of the Prior Art

Anti-reflective coatings are applied to transparent, substantially transparent and light submissive substrates for the purpose of reducing glare and reflection from the substrate surface. A major application of anti-reflective coatings is in the display industry comprised of televisions, computer monitors, cathode ray tubes (CRTs), flat panel displays, and display filters for the above, among others. Anti-reflective coatings have been a great benefit to the display industry in that such coatings have made the displays easier and more pleasant to view and have helped to reduce eyestrain in the workplace. A further application of anti-reflective coating is in the preparation of glass or other substrates for picture framing, sometimes referred to as framing glass or framing substrate. In addition to exhibiting glare and reflection reduction, framing glass also preferably exhibits anti-static properties. Such anti-static properties are preferred to prevent the substrate from attracting art work components such as chalk and the like or other free particles.

A large number of anti-reflective coatings currently exist in the art. One of the simplest anti-reflective coatings is a single layer of a transparent or substantially transparent material having a refractive index less than that of the substrate on which it is applied. The optical thickness of such layer is generally about one-quarter wavelength at a wavelength of about 520 nanometers.

Multiple layer anti-reflective coatings, which are comprised of two or more layers of substantially transparent materials, also exist. These multi-layer anti-reflective coatings usually have at least one layer with a refractive index higher than the refractive index of the substrate and at least one other layer with a refractive index lower than the substrate. Of the multi-layer anti-reflective coatings, most comprise alternating layers of a high refractive index material and a low refractive index material, with the low refractive index material comprising the outermost layer of the coating. Thus, in conventional anti-reflective coating design, the layer that is furthest from the substrate is a low refractive index material preferably having a refractive index less than the refractive index of the substrate. Multi layer anti-reflective coatings can be comprised of two, three, four or more layers. Anti-reflective coatings comprised of one or more layers are often referred to as an anti-reflective stack.

The individual layers of an anti-reflective coating can be comprised of electrically conductive material layers so that the anti-reflective coating is electrically conductive such as shown in U.S. Pat. No. 5,362,552 or can be comprised of materials which attenuate the light passing through the coating such as is shown in U.S. Pat. No. 5,091,244. Anti-reflective coatings, which attenuate light, are particularly applicable to sunglasses, to contrast enhancement filters and to solar control glazings to reduce the amount of sunlight to the interior of, for example, a vehicle or building.

Anti-reflective coatings can be applied to a variety of substrates including, but not limited to, transparent or substantially transparent glass or plastic substrates.

A drawback of anti-reflection coatings, and in particular optical interference anti-reflective coatings, is that they readily show fingerprints and are more difficult to clean than the corresponding uncoated substrate. It is believed that a principal reason for this is that skin oil from a fingerprint has a higher index of refraction than the effective refractive index of the anti-reflective stack. As is generally recognized in the art, a high index material or film (such as a fingerprint), on top of an anti-reflective coating will tend to destroy the anti-reflective nature of the coating, thereby making the fingerprint much more visible. In general, a substrate coated with an anti-reflective coating more readily shows contamination because of the higher degree of contrast between the contamination and the anti-reflective film. A substrate coated with an anti-reflective film is also more difficult to clean because the anti-reflective film typically has a higher surface energy than the uncoated substrate, thereby resulting in the contamination clinging more tenaciously to the surface.

Because of the difficulty in cleaning conventional anti-reflective surfaces, the market has demanded, and the industry has responded with, anti-adhering treatments for anti-reflective surfaces to facilitate the easy cleaning of such surfaces. One approach has been to create a super-hydrophobic surface on the anti-reflective coating of a substrate by first creating an initially super-hydrophilic, porous film such as Al₂O₃ by sol-gel methods. This porous film is then treated with fluoro-chemicals to minimize the surface energy and render it super-hydrophobic and thus easily cleaned.

A second approach is to provide the anti-reflective coating of a substrate surface with an anti-soiling coating such as a fluorinated siloxane material as disclosed in International Publication Nos. WO 99/06490 and WO 99/37720.

While many of the currently available anti-soiling or other coatings and treatments for anti-reflective coatings are generally acceptable in that they facilitate the cleaning of anti-reflective coated substrates, they tend to be quite expensive, both in terms of materials and the labor for application. Further, because many anti-reflective coatings as well as the substrates on which they are applied are employed and selected for their optical properties such as light transmission, color, ability to reduce reflection, etc., and because the application of any additional coating on an anti-reflective coating may adversely affect one or more of these desired optical properties, any such additional coating must be carefully selected.

Accordingly, there is a need for an anti-reflective coating or a modification thereof which is cost effective, which is easily cleaned, and which has minimal effect on the optical properties of the coated substrate. There is also a need for an anti-reflective coating or a modification thereof which exhibits improved anti-static properties for use in framing glass or the like where such properties are desired.

### SUMMARY OF THE INVENTION

In general, the present invention relates to an anti-reflective coating for a substrate which is cost effective, which facilitates easy cleaning of the anti-reflective coating which has minimal, if any, effect on the optical performance of the coated substrate and which also exhibits improved anti-static properties. The invention also relates to a method of applying an anti-reflective coating to a substrate.

In accordance with the present invention, the anti-reflective coating includes a conventional anti-reflective stack applied to the substrate and a thin metal oxide layer applied to the outer surface of the anti-reflective stack. The metal oxides that are usable in the present invention are metal oxides which exhibit a refractive index greater than that of the underlying substrate. This will normally be about 1.52 or more. More preferably, this metal oxide layer has a refractive index greater than 1.6 and most preferably, a refractive index greater than 1.7. Examples of metal oxides which can serve as this outer layer include titanium dioxide (TiO₂), zirconium dioxide (ZrO₂), yttrium oxide (Y₂O₃), niobium oxide (Nb₂O₅), hafnium dioxide (HfO₂), cerium dioxide (CeO₂), tin dioxide (SnO₂) and aluminum oxide (Al₂O₃), among others. It is believed that these metal oxides react to some extent with atmospheric carbon or other sources of carbon to form C—H bonds on the metal oxide surface. The existence of these C—H bonds tends to reduce the surface energy of that surface and thus facilitate easy cleaning of the coated substrate.

To minimize any adverse effect of the metal oxide layer on the optical performance of the underlying anti-reflective stack, the metal oxide layer should be as thin as possible, while still being thick enough to form a continuous film over the outer surface of the anti-reflective stack. Such continuous film provides sites for C—H bonding with atmospheric carbon or other carbon sources over the entire surface. Most preferably, the metal oxide layer should be less than about 10 nanometers thick.

Because the application of any coating, particularly a high refractive index coating, on an anti-reflective stack will impact the optical properties of the stack, usually in a negative way, a further aspect of the present invention is to re-optimize the anti-reflective stack with the additional metal oxide layer applied to its outermost surface. This re-optimization can be done physically by trial and error or the like or can be done utilizing various available software, such as TFCalc. In some cases, this re-optimization will result in a reduction in the thickness of the outer layer of the anti-reflective stack to compensate for the added metal oxide layer and thus a net cost saving.

In some applications, the anti-reflective stack and metal oxide layer is applied to only one side of a substrate. In other applications, however, particularly for framing glass, the anti-reflective stack and metal oxide layer is applied to both sides of the substrate.

The metal oxide layer can be applied via any conventional thin film application technique. Preferably, however, it should be applied via the same process and technique by which the underlying anti-reflective stack is applied. If this is done, the anti-reflective stack and the metal-oxide layer can be applied in a single application pass. A preferred method of applying the anti-reflective stack and also applying the thin metal oxide layer is by vacuum sputtering.

The method aspect of the present invention includes providing a substrate to be coated, applying an anti-reflective stack to at least one surface of the substrate and then applying a thin, high refractive index metal oxide layer to the outer surface of the anti-reflective stack. Although the anti-reflective stack and the metal oxide can be applied via a variety of thin film techniques, the preferred method of applying both the anti-reflective stack and the metal oxide layer is via a vacuum sputter process.

Accordingly, it is an object of the present invention to provide an anti-reflective coating for a substrate.

Another object of the present invention is to provide an anti-reflective coating for a substrate in which the coating is cost effective, facilitates easy cleaning of the substrate and has minimal, if any, effect on the optical properties of the underlying anti-reflective stack.

Another object of the present invention is to provide an anti-reflective coating which is cost effective and easy to clean and which may be applied in a single application pass.

A still further object of the present invention is to provide an improved method for applying an anti-reflective coating.

A still further object of the present invention is to provide a method of applying an anti-reflective coating which is cost effective and easy to keep clean, which exhibits anti-static properties and which may be applied in a single pass such as by vacuum sputtering or the like.

These and other objects of the present invention will become apparent with reference to the drawings, the description of the preferred embodiment and the appended claims.

### DESCRIPTION OF THE DRAWINGS

FIG. 1 is a schematic sectional view of a substrate and an applied anti-reflective coating in accordance with the present invention, including a single layer anti-reflective stack.

FIG. 2 is a schematic sectional view of a substrate with an applied anti-reflective coating in accordance with the present invention, including a four layer anti-reflective stack.

FIG. 3 is a schematic sectional view of a substrate with an applied anti-reflective coating in accordance with the present invention, including a multi-layer anti-reflective stack.

FIG. 4 is a schematic sectional view of a substrate with an anti-reflective coating in accordance with the present invention applied to both sides of the substrate.

### DESCRIPTION OF THE PREFERRED EMBODIMENT

The present invention relates generally to an anti-reflective coating for a substrate and a method of applying an anti-reflective coating to a substrate. The anti-reflective coating in accordance with the invention includes an anti-reflective stack applied to a substrate and a thin high refractive index metal oxide coating applied to the outer surface of the anti-reflective stack. The preferred method in accordance with the present invention includes providing a substrate to be coated, applying an anti-reflective stack to the substrate and applying a thin, high refractive index metal oxide layer to the outer surface of the anti-reflective stack. The invention further contemplates and includes the provision of an anti-reflective stack in which the desired optical properties have been re-optimized to compensate for the added metal oxide layer.

The substrate to which the anti-reflective coating is applied in accordance with the present invention may include any transparent, substantially transparent or light transmissive substrate such as glass, quartz or any plastic or organic polymeric substrate. Further, the substrate may be a laminate of two or more different materials and may be of a variety of thicknesses. The substrate may also be rigid or flexible (such as a rolled film) and may be a substrate which includes a primed surface or a surface with a chemical or other material layer applied thereon.

In describing the present invention, both the term “anti-reflective coating” and the term “anti-reflective stack” are used. In general, unless otherwise indicated, the term “anti-reflective coating” with reference to the present invention shall include an “anti-reflective stack” as defined below in combination with the high refractive index metal oxide layer. The term “anti-reflective stack” with reference to the present invention shall include any single layer of material or multiple layers of materials which function to provide an anti-reflective property to a substrate on which such “anti-reflective stack” is applied. Such “anti-reflective stack” may include, among others, conventional anti-reflective stacks or coatings and any anti-reflective stacks or coatings that have been re-optimized or otherwise adjusted to compensate for the added high refractive index material metal oxide layer in accordance with the present invention.

In describing the individual layers of an anti-reflective stack or an anti-reflective coating and the high refractive index metal oxide layer, it is recognized that any of these layers could have impurities resulting from a variety of sources including, among others, the lack of a contamination-free coating chamber in a sputter process or any other thin film application process and the fact that the target materials in a sputter process can include impurities. Further, some target materials may include intentionally added other materials. For example, a silicon dioxide (SiO₂) target material for a sputter process usually includes some aluminum (as much as 5% or more) to hold the SiO₂ together on the target. Thus, when individual layers of an anti-reflective stack or coating are identified and disclosed, or the high refractive index metal oxide layer is identified and disclosed, these layers are comprised substantially of the materials identified and disclosed and recognize that they can also include other materials in small amounts which may be intentionally added or may be a result of contamination or the application process employed.

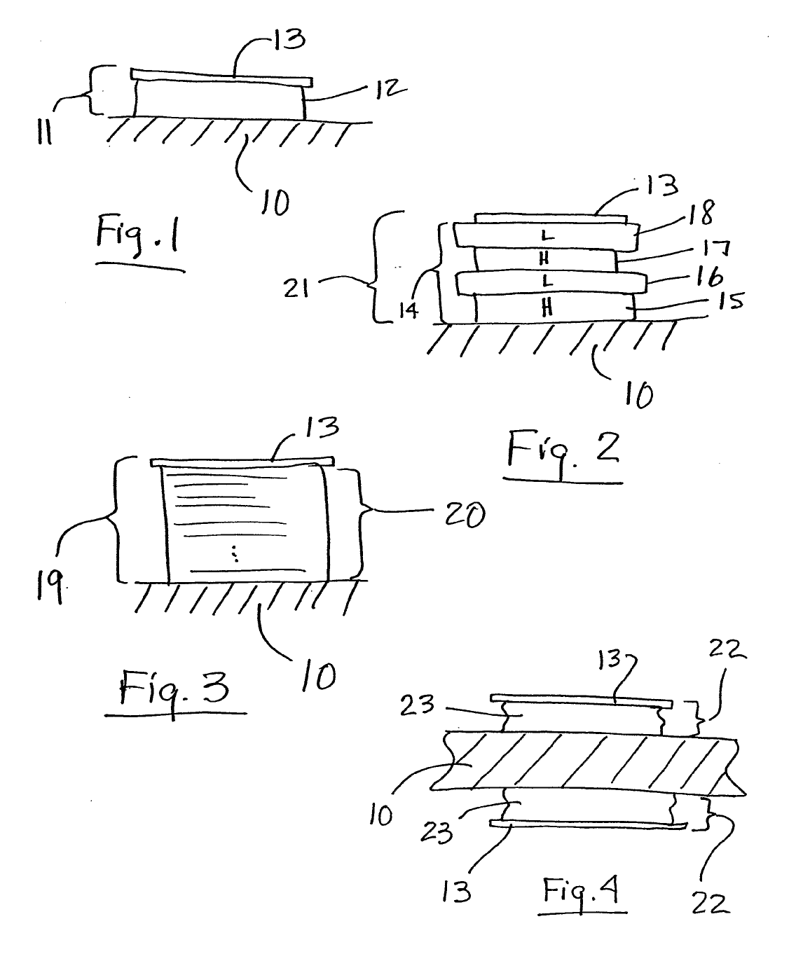

FIG. 1 is a schematic illustration of an anti-reflective coating 11 in accordance with the present invention applied to a substrate 10. The anti-reflective coating 11 includes an anti-reflective stack 12 in its simplest form and a layer 13 of a high refractive index metal oxide. In FIG. 1, the anti-reflective stack 12 is comprised of a single layer of a transparent, substantially transparent, or light transmissive material, which has a refractive index less than the refractive index of the substrate 10 on which it is applied. Single layer anti-reflective stacks exist in the art and may be formed of an organic material such as a polymer or an inorganic material such as a metal fluoride, metal oxide or metal nitride. Necessarily, the material of such single layer anti-reflective stack has a refractive index less than the refractive index of the substrate to which it is applied.

In FIG. 2, the anti-reflective coating 21 includes a multiple (four) layer anti-reflective stack 14 and a high refractive index metal oxide layer 13. The anti-reflective stack 14 of FIG. 2 is comprised of four individual layers 15, 16, 17 and 18. As is conventional in many anti-reflective stacks, the stack 14 is comprised of alternating layers of high and low refractive index materials, with the layer furthest from the substrate being a low refractive index material and the layer closest to the substrate being a high refractive index material. Specifically, in the stack 14 of FIG. 2, the first or outermost layer 18 furthest from the substrate 10 and the third layer 16 are comprised of low refractive index materials. The second layer 17 and the fourth layer 15 which is closest to the substrate 10 are comprised of high refractive index materials. As used herein, unless otherwise indicated, the terms “high refractive index” and “low refractive index” material are relative to the refractive index of the underlying substrate or to the refractive index of the adjacent layer in a stack.

In FIG. 3, the anti-reflective coating 19 applied to the substrate 10 is comprised of the anti-reflective stack 20 and the high refractive index metal oxide layer 13. In FIG. 3, the stack 20 is comprised of a plurality of individual layers of material with an undetermined number of layers. Like the stack structure of FIG. 2, this plurality of layers in the stack 20 may be comprised of layers of alternating high and low refractive indices, with the outermost layer furthest from the substrate usually having a refractive index less than the refractive index of the substrate. Multiple layer anti-reflective stacks can be comprised of two, three, four or more layers.

FIG. 4 is representative of a substrate which has been coated with an anti-reflective coating in accordance with the present invention on both sides. Such a structure is particularly applicable to framing glass and more particular to high end framing glass such as “museum” glass. In FIG. 4, the substrate 10 is provided with an anti-reflective coating 22 on both of its major surfaces. This coating 22 is comprised of an anti-reflective stack 23 and the outer layer 13 comprised of a high refractive index metal oxide. The anti-reflective stack 23 may be a single layer stack as shown on FIG. 1 or a multi-layer stack such as shown in FIGS. 2 and 3.

FIGS. 1-4 are representative of anti-reflective coatings in accordance with the present invention utilizing a variety of known anti-reflective stacks. In each of these stacks, the outermost layer of the stack furthest from the substrate is usually a low refractive index material layer with a refractive index lower than the refractive index of the substrate. Specific examples of anti-reflective stacks are disclosed in U.S. Pat. Nos. 5,091,244; 5,105,310; 5,372,874; 5,147,125; 5,372,874; 5,407,733; 5,450,238; 5,579,162 and 5,744,227, the disclosures of which are incorporated herein by reference.

In each of FIGS. 1-4, an anti-reflective stack is applied to at least one of the major surfaces of the substrate 10 and a thin, high refractive index metal oxide layer 13 is applied as the outermost layer to the anti-reflective stack. In the preferred embodiment, the metal oxide layer 13 is a metal oxide layer which has a refractive index greater than the refractive index of the underlying substrate to which the coating is applied.

It is believed that these high refractive index metal oxides have properties which facilitate reaction with atmospheric carbon or other sources of carbon to create C—H bonds at the outer surface of the layer 13. It is believed that these C—H bonds lower the surface energy of the layer 13 to a sufficient degree and thus facilitate easy cleaning of the anti-reflective coating. In general, it is believed that the metal oxides, which react with atmospheric carbon or other sources of carbon in this manner and are thus applicable for use in the present invention, will have a refractive index greater than the refractive index of the substrate. More preferably, this metal oxide layer 13 will have a refractive index greater than 1.6 and most preferably, a refractive index greater than 1.7. Specific metal oxides which are applicable for use in the present invention include: titanium dioxide (TiO₂), zirconium dioxide (ZrO₂), yttrium oxide (Y₂O₃), niobium oxide (Nb₂O₅), hafnium dioxide (HfO₂), cerium dioxide (CeO₂), tin dioxide (SnO₂), and aluminum oxide (Al₂O₃), among others.

Many of the high refractive index metal oxide materials applicable for use in the present invention will exhibit a sufficient increase in hydrophobicity and thus a decrease in surface energy as a result of being exposed to atmospheric carbon. In some cases, particularly if it is desired to increase the rate at which the surface energy of the metal oxide layer is reduced, the metal oxide layer can be exposed to organic substances or carbon sources other than atmospheric carbon. Other organic substances or carbon sources that have shown to be effective include glycerin, alcohol, citrus oil, skin oil, water-soluble machining oils and various organic adhesives.

A further property exhibited by the anti-reflective coating in accordance with the present invention is an anti-static property. The degree to which a surface exhibits anti-static properties is a function of its conductivity or lack thereof. In general, the more conductive a surface is, the better the anti-static properties. In contrast, the more resistance (often referred to as “sheet resistance”) a surface exhibits, the poorer the anti-static properties. The anti-reflective coatings in accordance with the present invention have been shown to exhibit improved anti-static properties and many in which the metal oxide layer includes zirconium oxide and/or tin oxide, among others, have exhibited anti-static properties at a level below 10¹⁴ ohms per square. This level of sheet resistance (or lower) is the level which a coated substrate should preferably exhibit to have acceptable anti-static properties for framing glass.

The metal oxide layer 13 should be as thin as possible, while being thick enough to cover the entirety of the outer layer of the anti-reflective stack and thus provide a continuous layer over the outermost surface of the anti-reflective stack. Preferably, the thickness of the metal oxide layer 13 should be 15 nanometers or less, and more preferably 10 nanometers or less. In the preferred embodiment, the thickness of the metal oxide layer 13 is maintained between about 3 and 7 nanometers. The actual preferred thickness of the layer 13 is determined by the index of refraction of the metal oxide layer 13 and the ability of the underlying anti-reflective stack to be re-optimized or adjusted to compensate for the added high index layer 13.

Because the provision of a metal oxide layer with a refractive index greater than the refractive index of the substrate is counter-intuitive or inconsistent with conventional anti-reflective coating design, the metal oxide layer 13 should be kept as thin as possible, while still being thick enough to provide a continuous layer over the outer surface of the anti-reflective stack.

In general, the application of any layer of material on an outer surface of a coated substrate will, to some extent, affect the optical performance of the coated substrate. Thus, addition of the metal oxide layer 13 to the outer surface of the anti-reflective stack will affect the optical performance of that stack to some extent, including its anti-reflective performance. The degree to which the optical performance is affected will depend on various factors including the thickness of the layer 13 and the index of refraction of the specific metal oxide which makes up the layer 13, among others.

Accordingly, a further and preferred feature of the present invention is to adjust or re-optimize the underlying anti-reflective stack to compensate for, and thus minimize, any adverse effect of the layer 13 on the optical performance of the anti-reflective stack and thus the optical performance of the entire anti-reflective coating. More specifically, the underlying anti-reflective stack is re-optimized by adjusting the thickness of one or more of its individual layers to compensate for the added metal oxide layer 13.

This modification of the anti-reflective stack to optimize the optical performance of the anti-reflective coating may be accomplished by trial and error, by computer modeling or by any other means of determining the adjustments in the underlying anti-reflective stack which may be needed to compensate for adverse optical effects resulting from the addition of the layer 13.

To evaluate the optical performance of the anti-reflective coating in accordance with the present invention, a variety of anti-reflective coatings, with an added high refractive index metal oxide outer layer, in accordance with the present invention, were compared to a conventional anti-reflective stack without such additional layer. Specifically, three different variations of a high refractive index metal oxide layer on a conventional anti-reflective stack known as PLASTAR were modeled using TFCalc software. The specific high refractive index metal oxide layers that were modeled included a five-nanometer layer of titanium dioxide, (TiO₂), a three-nanometer layer of titanium dioxide (TiO₂) and a five-nanometer layer of zirconium dioxide (ZrO₂).

First, in order to get a nominal conventional anti-reflective stack (in this case PLASTAR) centered in the color box, the conventional anti-reflective stack was optimized to a color of x=0.250, y=0.200. This is shown in the first main column of Table 1. Each of the above-mentioned high refractive index metal oxide layers was then modeled on top of the nominal anti-reflective stack and all layers, except the high-refractive index metal oxide layer were optimized by TFCalc software to the center of the color box, namely, x=0.250, y=0.200. This resulted in the layer thicknesses, color and design for the nominal stack and for each of the metal oxide coated stacks as shown in the second, third and fourth man columns of Table 1 below.

TABLE 1

| Nominal PLASTAR | | 5 nm TiO₂ Metal | | 3 nm TiO₂ Metal | | 5 nm ZrO₂ Metal | |
|---|---|---|---|---|---|---|---|
| Design | | Oxide Layer | | Oxide Layer | | Oxide Layer | |
| | Thickness | | Thickness | | Thickness | | Thickness |
| | (nm) | | (nm) | | (nm) | | (nm)- |
| Substrate | — | Substrate | — | Substrate | — | Substrate | — |
| SnO₂ | 25.23 | SnO₂ | 22.76 | SnO₂ | 23.95 | SnO₂ | 23.94 |
| SnO₂ | 21.36 | SnO₂ | 20.50 | SnO₂ | 20.54 | SnO₂ | 21.71 |
| SnO₂ | 77.35 | SnO₂ | 81.13 | SnO₂ | 80.65 | SnO₂ | 78.95 |
| SnO₂ | 91.59 | SnO₂ | 68.63 | SnO₂ | 77.37 | SnO₂ | 76.93 |
| — | — | TiO₂ | 5.00 | TiO₂ | 3.00 | ZrO₂ | 5.00 |
| Air | — | Air | — | Air | — | Air | — |
| Y | 0.29% | Y | 0.51% | Y | 0.37% | Y | 0.35% |
| x | 0.251 | x | 0.251 | x | 0.251 | x | 0.251 |
| y | 0.199 | y | 0.200 | y | 0.199 | y | 0.199 |

Y = Photopic Reflection

Based on the modeling calculations, color sensitivity for each of the three metal oxide layers varied, with the greatest impact shown in the thicker layers. The impact on the change in color sensitivity, however, did not appear to be significant in either of the cases. With respect to the effect of the additional high refractive index metal oxide layer on reflection, the five nanometer titanium dioxide layer increased the photopic reflection of the coating by about 0.22%, while the three nanometer titanium dioxide layer increased the photopic reflection of the coating by about 0.08% and the five nanometer zirconium dioxide layer increased the reflection of the coating by about 0.06%. These latter two were well within acceptable levels, depending on the particular application.

A further study was done to evaluate tin oxide (SnO₂) as the metal oxide layer and in particular, the impact which a five nanometer layer of tin oxide (SnO₂) would have on the optical performance of a conventional anti-reflective stack. In this evaluation, to get a normal stack design, a conventional anti-reflective stack known in the art as AQAR was optimized to color box coordinates x=0.250, y=0.148. After that, all of the layers except the five nanometer tin oxide layer were optimized to the nominal anti-reflective stack design and to the color coordinates x=0.250, y=0.148. This gave the following layer thicknesses, color and design for the nominal anti-reflective stack, both with and without the five nanometer tin oxide outer layer as shown in Table 2 below.

TABLE 2

| | |
|---|---|
| | 5 nm SnO₂ Metal |
| Nominal AQAR Design | Oxide Layer |

| | Thickness (nm) | Thickness (nm) |
|---|---|---|
| Substrate | — | — |
| (GLSN) | | |
| SnO₂ | 43.00 | 41.54 |
| SiO₂ | 23.00 | 22.96 |
| Nb₂O₅ | 32.00 | 32.83 |
| TiO₂ | 7.00 | 7.00 |
| SiO₂ | 100.00 | 87.75 |
| SnO₂ | — | 5.00 |
| Air | — | — |
| Y | 0.16% | 0.15% |
| x | 0.250 | 0.250 |
| y | 0.148 | 0.149 |

Y = Photopic Reflection

The results of this modeling showed that the five nanometer, tin oxide coating would have a relatively small negative impact on color sensitivity, but would otherwise not have appreciable impact on the reflection of the coating. Specifically, as shown in Table 2, the photopic reflection for the coating with the five nanometer layer of tin oxide actually decreases by 0.01% from 0.16% to 0.15%. Further, as shown in Table 2 above, reoptimization of the anti-reflective stack because of the addition of the five nanometer tin oxide layer results in a decrease in the thickness of the outer silicon dioxide (SiO₂) layer by about 12 to 13%. Thus, with the addition of the five nanometer tin oxide layer, the SiO₂ outer layer of the anti-reflective stack can be decreased by the above amount, without adversely impacting the anti-reflective capability of the overall coating and while still achieving the benefits of an anti-reflective coating which is easier to clean than the uncoated stack.

Similar reductions in the thickness of the outer SiO₂ layer of the reoptimized stacks in Table 1 are also shown. Thus, the addition of the thin TiO₂ and ZrO₂ layers show a benefit similar to that of SnO₂, namely, providing an anti-reflective coating with a reduced SiO₂ outer layer thickness, which is easier to clean and which still provides acceptable optical characteristics and anti-reflective properties.

Thus, the reduction of the outer layer, which is usually silicon dioxide, is great enough to compensate for most or all of the cost of adding the additional high refractive index metal oxide layer. Depending on the materials used, there can be a net variable cost savings for adding the metal oxide surface layer. Moreover, if the outer layer of the anti-reflective stack is deposited with a plurality of cathodes in a vacuum sputter process, the reduction of this outer layer thickness may allow changing the sputter material of one or more of the cathodes to the material that is used for the metal oxide layer. This allows the anti-reflective coating of the present invention to be implemented with little or no capital expenditure.

Accordingly, the present invention relates to an anti-reflective coating, which involves applying a thin high refractive index metal oxide layer to the outermost layer of an anti-reflective stack. This anti-reflective stack can be a conventional anti-reflective coating or stack or may be an anti-reflective coating or stack which has been re-optimized or adjusted to compensate for any optical property variance resulting from the addition of the high refractive index metal oxide layer. The invention also relates to a method of applying an anti-reflective coating to a substrate which includes the steps of applying an anti-reflective stack to a substrate and then applying a high refractive index metal oxide to the outermost surface of the anti-reflective stack. The anti-reflective stack in the method may also be a conventional anti-reflective coating or stack or an anti-reflective coating or stack which has been adjusted or re-optimized to compensate for any variation in optical performance resulting from the added metal oxide layer.

The anti-reflective coating of the present invention including the anti-reflective stack and the high refractive index metal oxide layer can be applied utilizing any of a variety of thin film application techniques including, but not limited to, vacuum sputtering, chemical vapor deposition and evaporation techniques, among others. The preferred method in accordance with the present invention, however, is vacuum sputtering and more specifically, reactive sputtering. Reactive sputtering and the particular techniques for applying particular types of material to produce anti-reflective stacks and other thin films via reactive sputtering are well known in the art. It is also preferable for the anti-reflective stack and the high refractive index metal oxide layer to be applied using the same thin film application technique or process. By doing so, the application of the anti-reflective stack and the application of the high refractive index metal oxide layer can be performed in a single pass through the thin film coating system.

Accordingly, a further aspect of the present invention is a method of applying an anti-reflective coating to a substrate by applying the anti-reflective stack (whether a single layer or multiple layers) and applying the high refractive index metal oxide layer to the substrate in a single pass through a thin film applicator. The preferred method in accordance with the present invention is to apply the anti-reflective stack and the metal oxide layer in a vacuum sputtering system. Thus, the preferred method includes providing a substrate, applying an anti-reflective stack to the substrate and applying a high refractive index metal oxide layer to the outermost layer of the anti-reflective stack, wherein the anti-reflective stack and the metal oxide layer are applied in a single pass in a vacuum sputtering system.

Although the description of the preferred embodiment has been quite specific, it is contemplated that various modifications may be made to the preferred embodiment without deviating from the spirit of the present invention. Accordingly, it is intended that the scope of the present invention be dictated by the appended claims rather than by the description of the preferred embodiment.

1. An anti-reflective coating for a substrate comprising:
an anti-reflective stack applied to said substrate, said anti-reflective stack having an outer layer spaced furthest from the substrate and
a metal oxide layer applied to said outer layer of said anti-reflective stack, said metal oxide layer having a refractive index greater than the refractive index of the substrate.

2. The coating of claim 1 wherein said metal oxide is selected from one or more of titanium oxide, zirconium oxide, yttrium oxide, niobium oxide, hafnium oxide, cerium oxide, tin oxide and aluminum oxide.

3. The coating of claim 2 wherein said metal oxide layer has a physical thickness less than about 15 nanometers.

4. The coating of claim 1 wherein said anti-reflective stack comprises a plurality of layers.

5. The coating of claim 4 wherein said plurality of layers includes alternating layers of a low refractive index material with a refractive index ranging from 1.35 to 1.65 at a wavelength of about 550 nm and a high refractive index material with a refractive index greater than 2.0 at a wavelength of about 550 nm.

6. The coating of claim 1 wherein said anti-reflective stack has been re-optimized to compensate for optical performance variation in the coating resulting from the application of said metal oxide layer.

7. The coating of claim 1 wherein said outer layer has a refractive index less than the refractive index of the substrate.

8. The coating of claim 1 wherein said metal oxide layer has a refractive index greater than 1.6.

9. A method of providing an anti-reflective coating to a substrate comprising:
providing a substrate to be coated;
applying an anti-reflective stack to at least one surface of said substrate and
applying a metal oxide layer to said anti-reflective stack, said metal oxide layer having a refractive index greater than the refractive index of the substrate.

10. The method of claim 9 wherein said metal oxide layer has a refractive index greater than 1.6.

11. The method of claim 10 wherein said anti-reflective stack has an outer layer with a refractive index less than the refractive index of said substrate.

12. The method of claim 9 wherein said anti-reflective stack is a multi-layer stack.

13. The method of claim 9 wherein said metal oxide layer has a physical thickness less than about 15 nanometers.

14. The method of claim 9 wherein said substrate is selected from glass or plastic.

15. The method of claim 9 including applying said anti-reflective stack to said substrate via a first thin film application process and applying said metal oxide layer to said anti-reflective stack via a second thin film application process.

16. The method of claim 15 wherein said first and second application processes are the same.

17. The method of claim 16 wherein said first and second application processes are vacuum sputter processes.

18. The method of claim 9 wherein said anti-reflective stack is a re-optimized stack which has been re-optimized to compensate for optical performance variation in the coating resulting from the application of said metal oxide layer.

19. A framing substrate comprising:
a light transmissive substrate having first and second major surfaces and
an anti-reflective coating applied to at last one of said first and second major surfaces, said anti-reflective coating comprising:
an anti-reflective stack applied to said at least one surface and
a metal oxide layer applied to the outer surface of said anti-reflective stack, said metal oxide layer having a refractive index greater than the refractive index of said substrate.

20. The framing substrate of claim 1 including an anti-reflective coating applied to both of said first and second major surfaces.
